(19) United States
(12) Patent Application Publication
(10) Pub. No.: US 2006/0237463 A1
(43) Pub. Date: Oct. 26, 2006

(54) Component seal for plastic tanks

(76) Inventor: Tony Riviezzo, Twinsburg, OH (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/408,329

(22) Filed: Apr. 21, 2006

Related U.S. Application Data
(60) Provisional application No. 60/673,677, filed on Apr. 21, 2005.

(51) Int. Cl. B62D 33/00

(52) U.S. Cl. 220/562

(57) ABSTRACT

The present invention is a tank with a body portion defining a cavity for the receipt of liquid. The tank has at least one opening in the body portion for receipt of a component, such as a gauge or pump. The tank has a first raised surface adjacent the opening in the body portion and a second raised surface spaced from the first raised surface. The first raised surface is generally rounded. The second raised surface has a generally knife shaped edge to prevent the ingress of contaminants into the tank and the egress of fluids when the component is connected to said tank.

The present invention relates to a seal for mounting a component such as a liquid level indicator, fuel gauge, pump, fuel pump etc. to a plastic tank. The present invention is particularly useful in tanks used in the marine industry and even more useful with marine fuel tanks, but can be used in any application where plastic tanks are used and require components to be mounted directly to the tank.

### BACKGROUND OF THE INVENTION

Tanks, particularly fuel tanks for the use in marine vehicles, are typically formed of plastic and have a number of components, such as for example fuel gauges and fuel pumps that must be attached to the tank in a liquid tight manner. The components are typically mounted to the tank by use of a separate insert that is made of either metal or plastic. The insert must be flat and smooth to provide a flat smooth surface for receiving the component and a seal, such as for example a flat gasket to ensure that the component is mounted to the insert in a liquid tight fashion.

When metal is used, it must be machined to a proper shape and have the proper openings to receive the various components that are intended to be connected to the fuel tank. The metal insert can be bolted to the fuel tank or molded into the fuel tank to provide the flat smooth surface for receipt of the component(s).

One of the problems with metal inserts is that they require the insert to be machined which is a costly process. Additionally, the use of metal is more costly than for example the use of plastic. There are also problems with the connection of the metal insert to the plastic container. The plastic container has a tendency to expand and contract with the change of temperature that a tank may experience on a given day of use. This expansion and contraction of the tank is different than the expansion and contraction experienced by the metal insert. With the different expansion and contraction between the metal and the plastic, the connection of the metal to the plastic can fatigue over time possibly resulting in the need to replace the tank.

Another method of connecting components to a fuel tank is through the use of a plastic insert that is molded and then fused to the fuel tank during the manufacture of the tank. Examples of these plastic inserts are described in U.S. Pat. Nos. 6,415,941 and 6,193,924, both of which are owned by the assignee of the present application. These plastic inserts are less expensive to manufacture than metal inserts. The ability to fuse the plastic insert into the tank provides a very tight seal between the insert and the tank. Additionally, the materials of the tank and the insert will expand and contract to about the same degree since they are made from the same materials or at least similar materials. There can be some differences in the relative expansion and contraction, due to the thicknesses of the parts, but this is not as significant as that found between metal and plastic. As with the metal plates, a flat gasket is needed to provide a seal between the component being attached and the plastic plate.

### SUMMARY OF THE INVENTION

The present invention overcomes the problems associated with metal inserts and provides an advantage over plastic inserts. Additionally, one embodiment of the present invention substantially reduces costs because the seal can be integrally formed in the surface of the tank obviating the need for a separate insert.

Generally, the present invention is a seal for sealing the connection of a component to an opening in a tank, such as for example a fuel tank. The seal includes a first raised surface that is positioned adjacent an opening in the tank and a second raised surface spaced from the first raised surface. The second raised surface has a generally knife shaped edge to prevent the ingress of contaminants and the egress of fluids when the component is connected to the tank. The first raised surface has a generally rounded shape. These surfaces can be formed in the tank in itself or they can be formed on an insert that is connected to the tank. The raised surfaces are formed from the same material as either the tank or the insert and are adapted to be crushed or deformed slightly when the component is attached. A plurality of fasteners are molded into the tank about the opening for connection of the component. The component is positioned in the opening in the tank and fasteners are used to pull the component into tight engagement with the tank deforming the raised surfaces slightly.

The invention is also directed to the tank which has a body portion defining a cavity for receipt of liquid, such as for example fuel. The tank has at least one opening in the body portion for receipt of a component. The tank includes a first raised surface adjacent the opening in the body portion and a second raised surface spaced from the first raised surface. The second raised surface has a generally knife shaped edge to prevent the ingress of contaminants into the tank and the egress of fluids when the component is connected to the tank.

In one embodiment, the first raised surface and the second raised surface are integrally formed in the body portion of the tank. In another embodiment, the first and second raised surfaces are formed on a separate insert that is adapted to be connected to the tank. The tank also includes a plurality of fasteners molded into the tank about the opening for connection of the component. The component could be a liquid level sensor, fuel gauge, pump, fuel pump of any other component.

### DESCRIPTION OF THE DRAWINGS

FIG. 1 is a perspective view of the seal of the present invention shown as an insert.

FIG. 2 is a top view of the seal of FIG. 1.

FIG. 3 is a cross sectional view of the seal of FIG. 1.

FIG. 4 is cross sectional view of the first and second seals.

FIG. 5 is a partial perspective view of the seals integrally formed in the tank.

### DETAILED DESCRIPTION

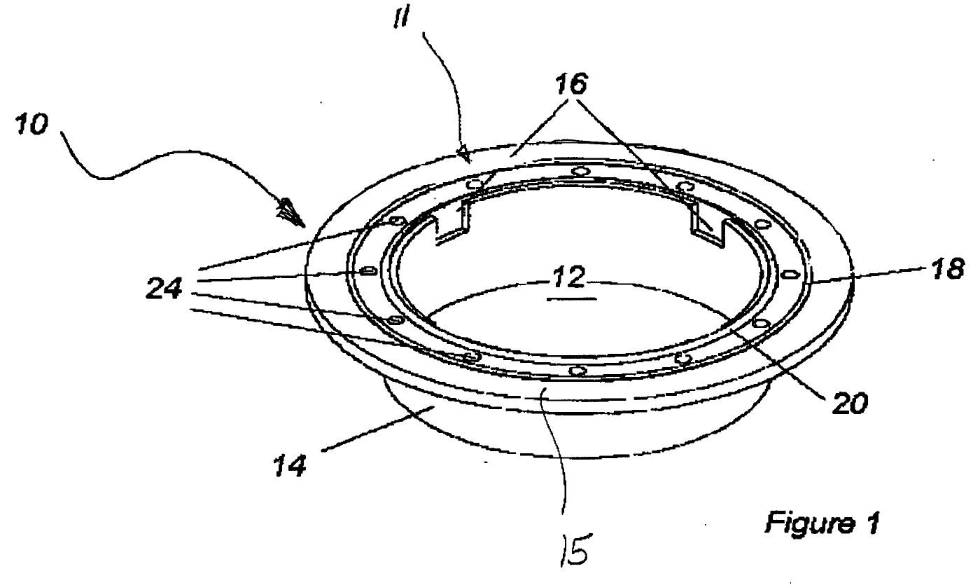

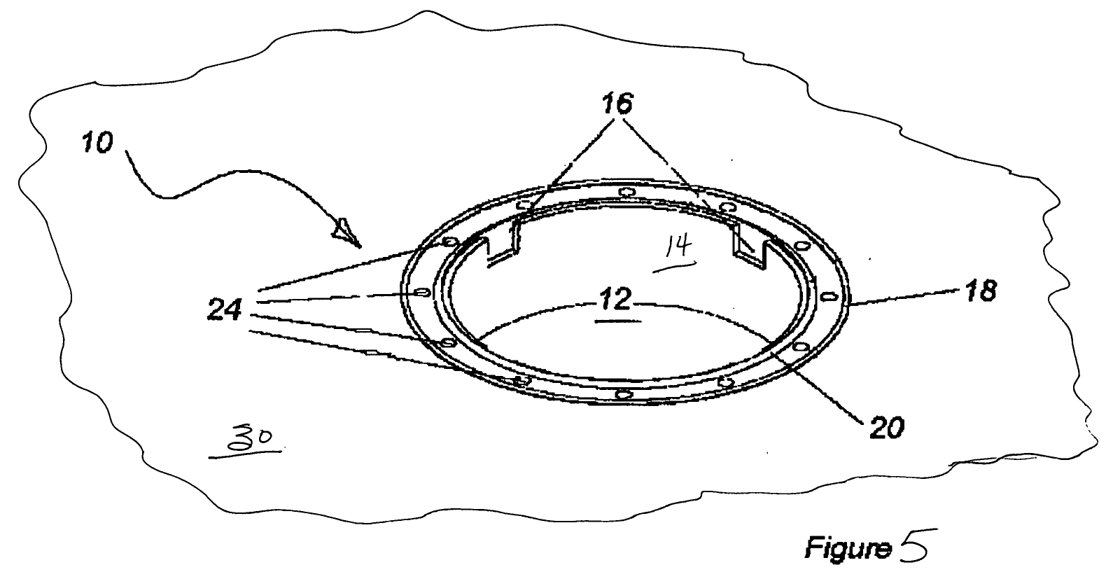

With reference to FIG. 1, the seal of the present invention is shown generally at 10. The seal 10 as illustrated is an insert 11 that can be connected to a tank, such as for example a fuel tank. The insert 11 is preferably connected to the tank by fusing the edges of the insert to the edges of the tank opening. This is most commonly done in the rota-molding process, but could be done later by welding etc. The insert could also be botted to the tank if desire. It should be understood by those of ordinary skill in the art that the seal 10 could be an insert 11 as illustrated in FIGS. 1 through 4, or it could be integral to the fuel tank as shown in FIG. 5. In the embodiment disclosed in FIGS. 1 through 4, the insert 11 is formed from plastic in an injection molding process. The seal 10 of FIG. 5 is formed with the tank in either a rota-molding process or by injection molding.

An opening 12 is formed in the insert 11 for receipt of a component, such as for example a liquid level indicator, water pump, standard fuel pump or fuel gauge, etc. The component is not shown, but it will be understood by those of ordinary skill in the art. Interior wall 14 extends into the fuel tank to locate the component, such as for example a fuel pump, when the fuel pump is inserted into the opening 12. The wall 14 stabilizes the fuel pump so that it is properly located within the fuel tank. In the disclosed embodiment, orientation notches 16 are formed in the wall 14 to properly orient the fuel pump when it is inserted. It will be understood by those of ordinary skill in the art that the component, in this example the fuel pump, would have mating locating features that mate with the orientation notches 16.

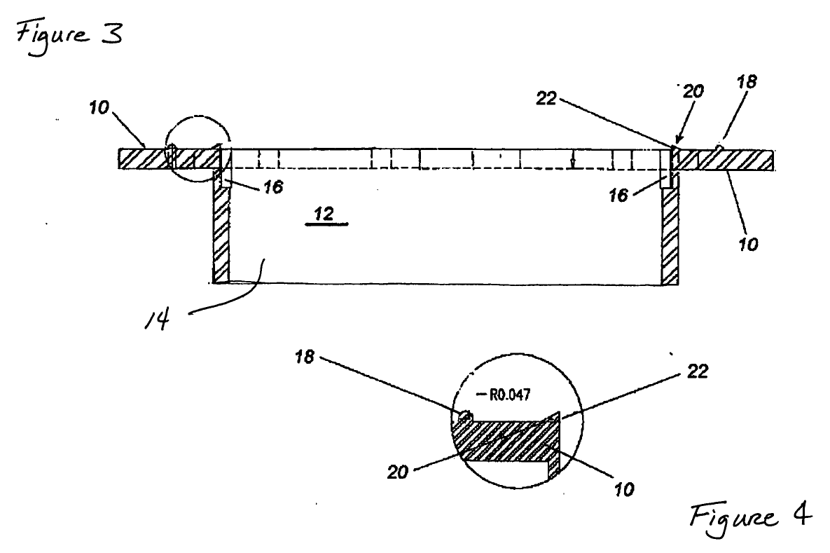

The flange 15 of the seal 10 has a pair of first and second raised surfaces or sealing compression rings 18 and 20. As shown in FIG. 3, the compression sealing rings 18 and 20 are formed integral to the flange 15. The first ring 18 is semi-round and in the disclosed embodiment has a radius of about 0.047 inches and a diameter at the base of about 0.09 inches. The second ring 20 is generally knife shaped as disclosed having a width of about 0.125 inches and a height of about 0.063 inches. The ring 18 is spaced outwardly from the opening 12 and the ring 20 is spaced from the ring 18 and is adjacent to the opening 12. The rings 18 and 20 seal the component with respect to the insert 11. Ring 20, with its knife shape, seals against fluid escaping from opening 12. The straight wall 22 of ring 20 forms a barrier to the egress of fluid. Additionally, in the event fuel does escape beyond the seal 20, the seal 18 prevents the fuel from escaping. Additionally, the seals 18 and 20 prevent the ingress of air or containments into the tank.

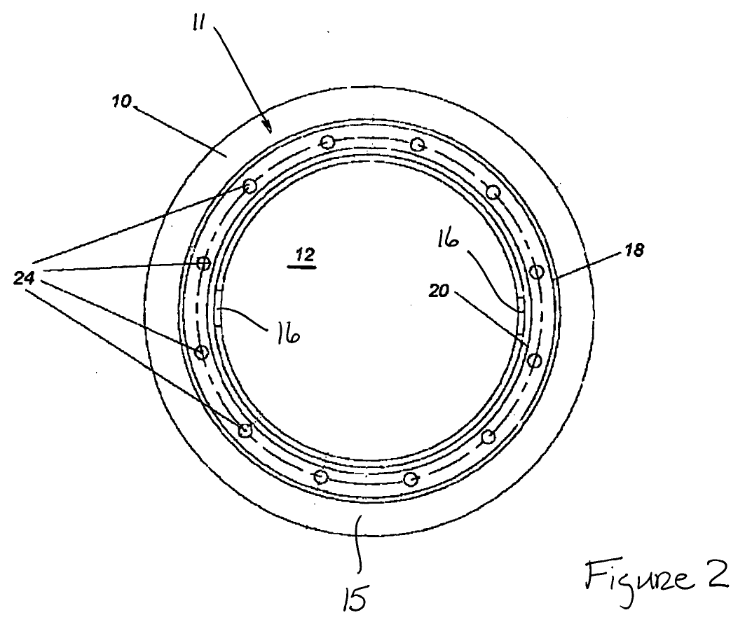

With reference to FIGS. 1 and 2, threaded inserts 24 are molded into the fuel tank to receive screws or bolts to fix the fuel pump in the fuel tank.

With reference to FIG. 5, the rings 18 and 20 are integrally formed in the tank 30 from the same material as the tank 30. The same numbers are used to identify like items as was used with respect to FIGS. 1 through 4. In the tank 30, the rings 18 and 20 are formed at the time the tank 30 is formed, typically either by rota-molding or injection molding.

It will be apparent that various changes and modifications in the illustrative embodiments of the invention, shown and described herein, can be made without departing from the scope of the invention as defined in the appended claims.

What is claimed is:

1. A tank comprising:
a body portion defining a cavity for the receipt of liquid;
at least one opening in the body portion for receipt of component;
a first raised surface adjacent the opening in the body portion;
a second raised surface spaced from said first raised surface;
said second raised surface having a generally knife shaped edge to prevent the ingress of contaminants into said tank and the egress of fluids when the component is connected to said tank.

2. The fuel tank of claim 1, wherein said first raised surface and said second raised surface are integrally formed in the body portion of said fuel tank.

3. The fuel tank of claim 1, wherein said first and second raised surfaces are formed on a separate insert that is adapted to be connected to said fuel tank.

4. The fuel tank of claim 1, wherein said first and second raised surfaces are sealing compression rings.

5. The fuel tank of claim 1, further including a plurality of fasteners molded into said fuel tank about said opening for connection of said component.

6. The fuel tank of claim 1, wherein said component is a fuel pump.

7. The fuel tank of claim 1, wherein said component is a fuel gauge.

8. The fuel tank of claim 1, wherein said tank is formed of plastic.

9. The fuel tank of claim 7, wherein said tank is formed by rota molding.

10. The fuel tank of claim 7, wherein said tank is formed by injection molding.

11. The fuel tank of claim 1, wherein said first and second raised surfaces are adapted to be compressed.

12. A seal for sealing the connection of a component to an opening in a tank, said seal comprising:
a first raised surface adjacent the opening;
a second raised surface spaced from said first raised surface;
said second raised surface having a generally knife shaped edge to prevent the ingress of contaminants and the egress of fluids when the component is connected.

13. The seal of claim 12, wherein said opening is in a tank.

14. The seal of claim 12, wherein said seal is formed from plastic.

15. The seal of claim 13, wherein said seal is integrally formed in said tank.

16. The seal of claim 13, further including a plurality of fasteners molded into said fuel tank about said opening for connection of said component.

17. The seal of claim 12, wherein said component is a pump.

18. The seal of claim 12, wherein said component is a liquid level gauge

19. The seal of claim 13, wherein said tank is formed by rota-molding.

20. The seal of claim 13, wherein said tank is formed by injection molding.

21. The seal of claim 13, wherein said first and second surfaces are adapted to be compressed.

22. The seal of claim 12, further including a flange, with said first and second raised surfaces being formed integrally with said flange.

23. The seal of claim 22, further including a wall extending generally perpendicular to said flange and adapted to guide the component in the tank.
